(19) United States
(12) Patent Application Publication
(10) Pub. No.: US 2007/0216708 A1
(43) Pub. Date: Sep. 20, 2007

(54) Handwritten-data-processing device and installation, which provide a certified data back-up with links

(75) Inventor: Wendy MACKAY, Paris (FR)

Correspondence Address: FOLEY AND LARDNER LLP;SUITE 500, 3000 K STREET NW, WASHINGTON, DC, 20007, US

(73) Assignee: INRIA INSTITUT NATIONAL DE RECHERCHE EN INFORMATIQUE ET EN AUTOMATIQUE

(21) Appl. No.: 10/532,086

(22) PCT Filed: Oct. 21, 2003
(86) PCT No.: PCT/FR03/03115

§ 371 Date: Apr. 18, 2007

(30) Foreign Application Priority Data
Oct. 23, 2002 (FR) 02/13238

(51) Int. Cl. G09G 5/00

(52) U.S. Cl. 345/619

(57) ABSTRACT

The invention relates to an improved handwritten-data-processing device and installation, which provide a certified data back-up with links. According to the invention, the data processing device comprises processing means (10) which are designed to address instructions to a display device (6), such as a PDA, said instructions requiring the display of at least one part of the primary handwritten data which is captured by recognition means (5) after being entered by a user in one zone (4) of a support (3). The aforementioned processing means (10) are also designed to associate (i) a timestamp, which represents the moment of data entry or association, and (ii) an identifier, which represents the zone (4), with the primary data and with the processing operators and/or secondary data which, at the user's command, are associated using interaction means (8) with at least some of the primary data displayed by the display device (6). Finally, when primary or secondary data designating external data which are stored, for example, in a database (9), are activated by the interaction means (8), the above-mentioned processing means (10) are designed to access said database such that the external data can be displayed by the display device (6).

The invention relates to the saving and archiving of handwritten information, in electronic form and in real time.

A number of solutions have been proposed to enable a person to save, in electronic form and in real time, information that he or she has transcribed onto a writing medium. These solutions include in particular graphic tablets and electronic pens.

A graphic tablet generally includes a sensitive surface intended to receive a writing medium, such as a sheet of paper, and coupled to means of recognizing data or handwritten information.

An electronic pen is a device equipped with a writing stylus and means capable of capturing data or information written with the stylus by analyzing its micro-movements on a writing medium. The latter makes it possible, when provided with pre-defined irregular reference marks or when coupled to an electromagnetic detection device, to determine the location where the information has been written. Such a pen is proposed in particular by the company Anoto.

In either case, the handwritten data is “captured” then saved in digital form, in correspondence with its respective positions, in an electronic file which can then be read by an IT device, such as a computer, so that the data can be displayed on a screen.

Certain data-processing applications allow a document containing digitized handwritten information to be annotated by hand. However, once said document has been annotated, it is generally no longer possible to differentiate the initial information from the information added subsequently and possibly at different times. This can be a source of dispute when the digitized document is used as evidence in court proceedings seeking to determine, for example, the true creator of an idea or an invention. There is therefore a real need for certification of the dates of data entries into a document that are spread over a period of time.

Moreover, by reason of the ever growing number of documents and information sources, it is becoming indispensable to establish durable links (or bridges), for example of the hypertext type (or on-line link) between information belonging to handwritten documents and other documents, handwritten or otherwise, and/or sources of public and/or private information.

There is also a serious need for indexing of documents or portions of digitized handwritten documents, in particular to facilitate accurate archiving or efficient searches.

Furthermore, there is a real need for portability of certain digitized handwritten documents so that handwritten annotations or additions can be made thereto at any location, such as a laboratory for example.

The aim of the invention is therefore to remedy all or some of the aforementioned drawbacks and/or needs.

To this end it proposes a data-processing installation including in combination:
a writing medium defining at least one zone enabling a user to enter handwritten primary data such as letters or numbers for example;
means of recognition to capture the primary data entered in the zone;
a display enabling data, in particular primary data, to be displayed;
means of interaction enabling a user i) to associate processing operators and/or secondary data, such as for example handwritten or non-handwritten characters, images, references, links (or addresses) or identifiers, with primary data entered in the zone, and ii) to activate primary data entered or associated secondary data when they designate external data stored in at least one database;
processing means arranged i) to associate a timestamp representing the time of data entry or association, and an identifier representing the zone, with the processing operators and/or with the primary or secondary data, and ii) in the case where a user activates primary or secondary data, to access the database in which the external data designated by the activated data is stored, such that this external data is displayed by the display device.

Thus, handwritten information entered by a user on a writing medium (such as for example an electronic notebook (a notebook with “pages” allowing electronic data input using a dedicated pen), a graphic tablet or a handwriting recognition screen) can be saved in real time, in a memory, in correspondence with a timestamp and an entry zone identifier, and can be subject at a later time to handwritten annotations or additions of any kind, and in particular processing operators, also saved in correspondence with a timestamp and/or processing using operators, for example bracketing, underscoring or font change. In addition, when digitized entered information is linked to other internal or external information, the user can access the latter in real time by activating the entered information.

It is important to note that the invention relates more particularly to the capture of the trace of handwritten characters and not the image of such characters. Therefore, the invention does not require, a priori, character recognition of the OCR type for example. It only requires recording of the traces left by the handwritten characters.

Preferably, the processing means are arranged so as to associate primary level and secondary level identifiers with the primary and secondary data in a zone. Furthermore, when the writing medium is of the electronic type, it can be arranged so as to deliver to the processing means tertiary data representing an input mask of the zone. In this case, the processing means are arranged to associate tertiary level identifiers with the tertiary data in a zone before storing it in the memory. In this way, the zone and its data can be broken down into levels (or layers), such as for example a preprinted layer (tertiary level), an initial handwritten information layer (primary level) and an annotation and addition layer (secondary level).

The installation according to the invention can include numerous additional characteristics which can be taken separately and/or in combination, and in particular:
recognition means which can include a pen arranged to enable a user to enter primary and/or secondary data via the writing medium, and to capture the primary and/or secondary data thus entered in order to communicate it to the processing means;
recognition means which can include a pen arranged to enable a user to enter primary and/or secondary data via the writing medium, in order to capture the primary and/or secondary data thus entered in cooperation with the recognition means, and then to communicate it to processing means;
recognition means which can include a graphic tablet to accommodate the writing medium and to capture the primary and secondary data entered on the writing medium, then to communicate it to the processing means;
a writing medium provided in the form of an electronic notebook defining a multiplicity of input zones for primary and/or secondary data, such as pages for example;
at least one computer connected to the recognition means and including the display and at least one part of the processing means, and possibly also at least one part of the interaction means;
at least one computer including the display, the recognition means, and at least one part of the processing means, and possibly also at least one part of the interaction means. In this case, it is particularly advantageous that the display screen constitutes the writing medium;
at least one Personal Digital Assistant (PDA) incorporating an auxiliary display arranged to facilitate the entry of secondary data by a user, at least one part of the interaction means, at least one part of the processing means, and a part of the recognition means, so as to capture the secondary data entered via the auxiliary display. Each PDA can be also equipped with tracking means connected to the recognition means and capable of determining the positioning of the auxiliary display screen of the PDA relative to the input surface, so that the part of the zone displayed on the PDA screen substantially matches the portion of the zone of the writing medium located under the PDA;
a computer connected to the Internet and/or to at least one private database (internal or external).

The invention also relates to a data processing device including processing means arranged so as to:
address instructions to a display requiring the display of at least one part of handwritten primary data captured by recognition means following entry by a user in one zone of a writing medium;
associate a timestamp representing the time of data entry or association and an identifier representing the zone, with the primary data, and with processing operators and/or secondary data, associated by interaction means with at least some of the primary data displayed by the display device, and
in case of activation by the interaction means, at the user's command, of primary or secondary data designating external data stored in a database, to access this database so that the external data is displayed by the display device.

Such a device can advantageously equip an installation of the type described above.

Other characteristics and advantages of the invention will become apparent upon examination of the following detailed description together with the attached drawings in which:

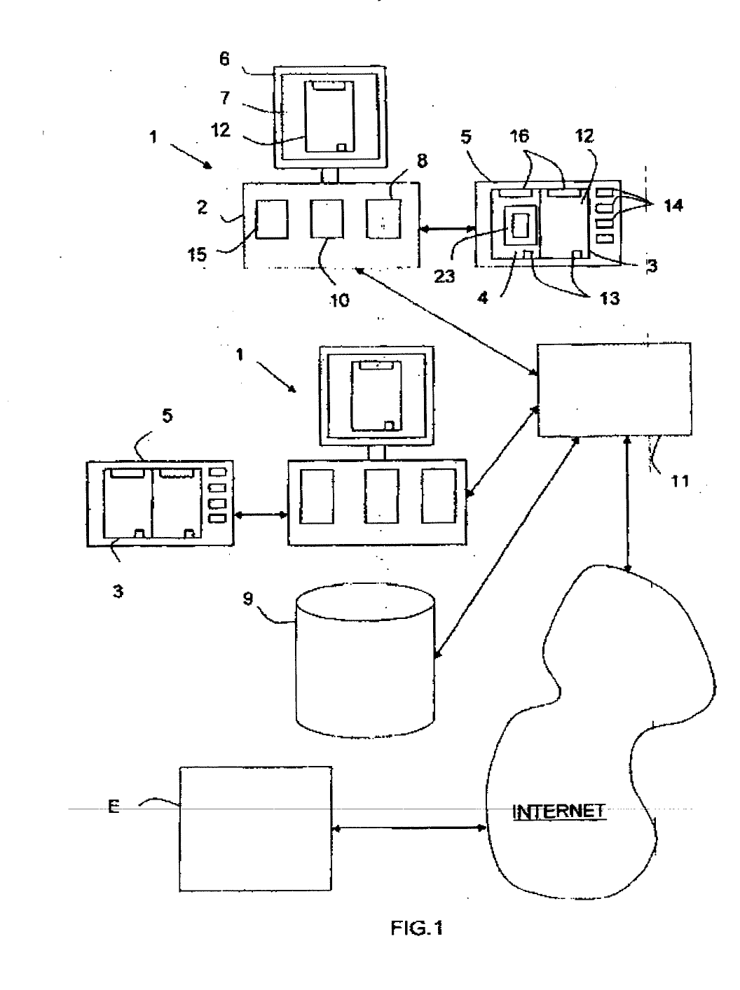

FIG. 1 is a schematic illustration of part of an installation according to the invention including computers linked to external recognition means;

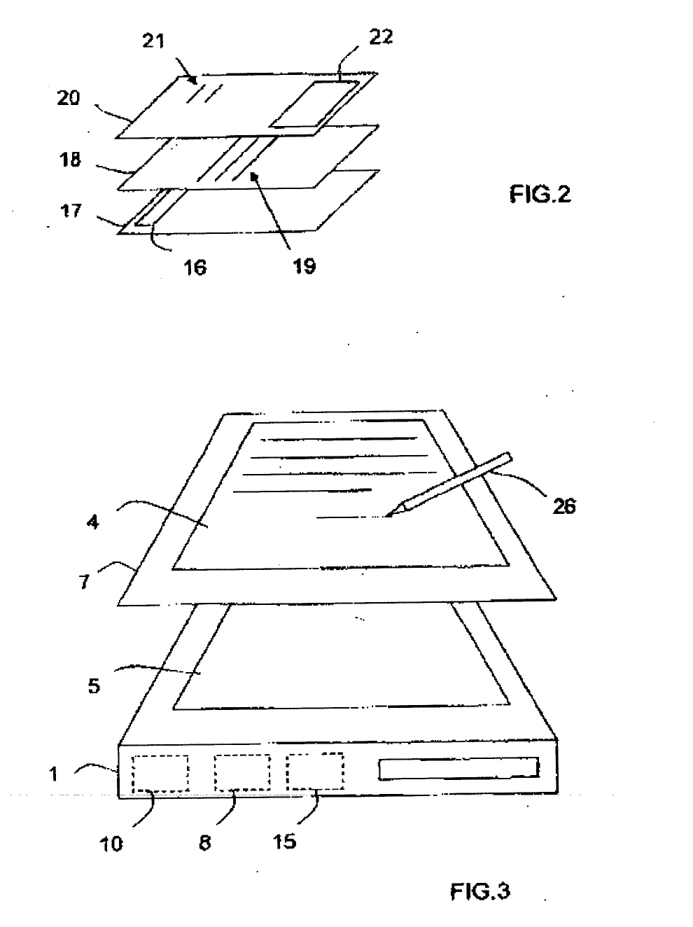

FIG. 2 is a schematic illustration of an example of the breakdown of a page into a multi-layered structure;

FIG. 3 is a schematic illustration of a variant of a computer including integral recognition means, and capable of being used in the installation according to the invention;

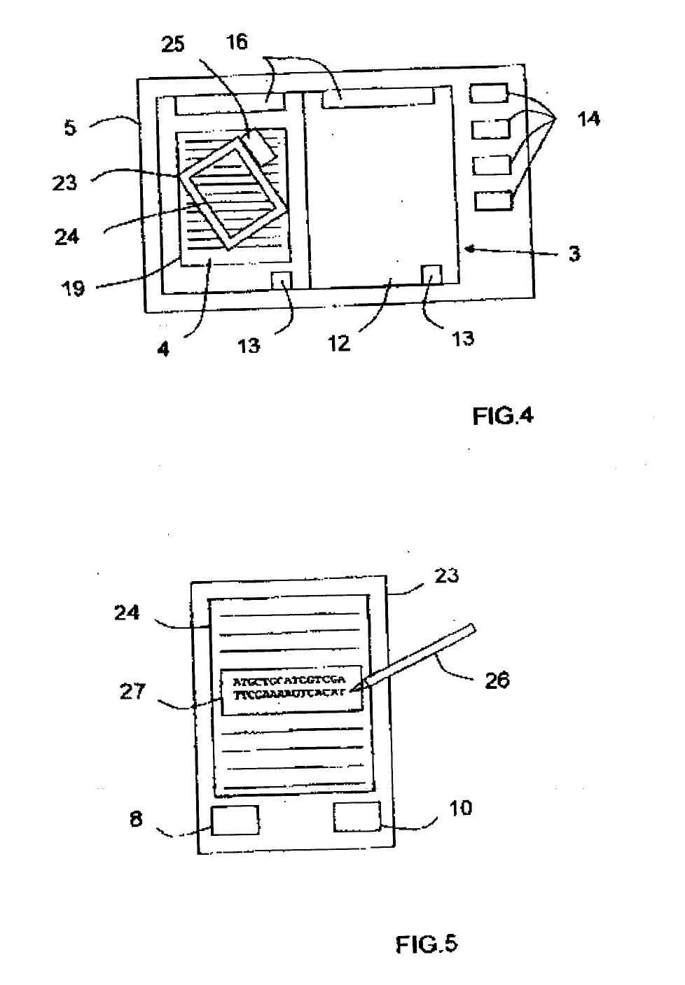

FIG. 4 details the graphic tablet of the installation in FIG. 1, linked to a personal digital assistant equipped with a tracking module, and

FIG. 5 is a schematic illustration of an example of data processing performed by means of a personal digital assistant forming part of the installation.

The attached drawings will not only serve to assist understanding of the invention, but will also contribute to its definition, as the case may be.

The invention proposes an installation and a device that make it possible in particular to capture information entered by users by means of data-processing equipment, to save this information in the form of digital data, also termed “on-line” data, in correspondence with a timestamp, to display this digital data in response to dedicated commands, and to establish links (or bridges) between the on-line digital data and so-called “off-line” or “physical” data stored in public or private databases.

To achieve this purpose, and as illustrated in FIG. 1, the installation according to the invention includes at least:
one computer 1, including at least one central processing unit 2;
a writing medium 3 defining one or more zones 4 enabling a user to enter data or handwritten primary characters, such as for example letters, numbers, diagrams or drawings;
a recognition module 5 capable of recognizing the data or primary characters entered in one of the zones 4;
a main display 6 capable of displaying at least part of the data or primary characters entered, such as for example a monitor or screen of a personal digital assistant (more generally known by the acronym PDA);
an interaction module 8 arranged so as to enable a user to associate processing operators and/or secondary data, such as handwritten or non-handwritten characters, images, references, links (or addresses) or identifiers, with at least some of the primary data displayed by the display device 6, and to activate primary or secondary data when they designate external data stored in at least one database 9;
a processing module 10 arranged so as to associate with the processing operators and with the primary or secondary data a timestamp representing the time of entry or association thereof and an identifier representing their assigned zone 4, and in the case of activation of primary or secondary data by a user, to access the database 9 in which the external data designated by the activated data is stored, such that this external data is displayed by the display device 6.

In the first embodiment illustrated in FIG. 1, the display device 6, termed the “main” display, forms part of the computer 1. It takes the form of a monitor having a so-called main screen 7 enabling a zone 4 of the writing medium 3 to be displayed. Furthermore, in this example the recognition module 5 takes the form of a graphic tablet arranged so as to accommodate the writing medium 3 for the entry of primary characters. This graphic tablet 5 is connected to the central processing unit 2 of the computer 1 by means of a hard-wired link or wireless link, for example via an infrared or Bluetooth interface.

The use of any graphic tablet 5 can be envisaged provided that it is capable of capturing the characters entered by the user via the writing medium 3 placed on its receiving surface. For example, it can function by pressure detection and by electromagnetic analysis, as in the particular case of the Intuos model made by the company WACOM.

Furthermore, the type of writing medium 3 depends on the type of recognition module 5. It can consist of one or more sheets of paper enabling the user to write with a conventional pen, for example an ink pen, or one or more electronic sheets linked to an electronic pen.

In the example illustrated, the writing medium 3 is a laboratory notebook including a multiplicity of sheets defining pages 12 delineating zones 4 for the entry of handwritten or non-handwritten characters.

Of course, other types of recognition module can be envisaged. Thus it is possible to employ a graphic tablet using certain electronic pens, such as for example those proposed by the company Anoto, linked to sheets having predefined irregular reference marks enabling the styluses of said pens to determine their positions relative to said sheets. Such an electronic pen is provided with recognition means which enable it to recognize written characters by analyzing its micro-movements. In addition it is equipped with a wireless interface which enables it to transfer the primary data, generated by the conversion of the characters entered, to the central processing unit 2.

In the example illustrated in FIG. 1, the processing module 10 is installed in the central processing unit 2 of the computer 1. It receives the primary data delivered by the recognition module, in this instance the graphic tablet 5, and on receiving the user's command, it transmits the data to the main display 6 so that it is displayed on main screen 7, or as a variant it transmits it to the PDA.

As illustrated, the installation can include a multiplicity of computers 1 networked together, of the Intranet type for example. In this case, each computer 1 is preferably connected to a recognition module 5, for example a graphic tablet, and to a server 11, for example linked to a private database 9 and preferably to the Internet, possibly via a firewall. Of course, however, each computer 1 could be directly connected to the Internet to facilitate access to remote information sources, whether private or public.

In the example illustrated, the interaction module 8 is installed, at least partially, in the central processing unit 2 of the computer 1. It enables the user to associate secondary data (annotations) and/or processing operators with the primary data, via the writing medium 3. It can also possibly be used in conjunction with an electronic or analogue pen, enabling the user to activate dedicated commands or certain information in the document displayed on the main screen 7 and/or to annotate the document. Of course, the display 6 (or the PDA) must be adapted for this purpose. It may for example be equipped with an interactive screen of the same type as those used in personal digital assistants (PDA) or LCD tablets. To this end, it can for example use the Cintiq 18X tablet screen made by the company WACOM.

The operation of the installation presented above will now be described in detail. After switching on the computer 1 and graphic tablet 5, the user places the writing medium 3, in this instance a laboratory notebook, on the graphic tablet 5, then opens the notebook at the chosen page 12. Two cases then need to be considered depending on whether or not the notebook 3 includes pages 12 having page numbers 13, as illustrated in FIG. 1.

Where the page numbers 13 are pre-entered, the user must tell the processing module 10 the number of the page on which he/she wishes to write. To do this, the user either activates one of the dedicated commands 14 in a menu offered by the graphic tablet 5, or uses a micro-scanner linked to the processing module 10, such as a PocketReader® for example, or writes the number in a dedicated input field on the page 12. The user can then start to write primary data or characters (letters, numbers, drawing lines, and the like) in the entry zone 4 of the chosen page. The graphic tablet 5 captures this primary data or characters, then converts them into primary digital data which it transmits, together with digital position data, to the processing module 10, in this instance installed in the computer 1. When the user has finished entering information, there is no need to notify the processing module 10 because the transfer and processing of the data are performed “on the fly”.

At this stage, this processing involves associating a timestamp representing the time of data entry and an identifier representing the assigned zone, in this instance a page 12 of a laboratory notebook 3, with the primary data and corresponding position data. The primary data, position data, timestamp and page identifier are stored in the memory 15 of the central processing unit 2, in a page-file of a folder previously created and corresponding to the user's laboratory notebook 3. The processing module 10 can then be configured to transfer automatically, or at the user's command, the updated folder (or the page-file only) to the corporate database 9.

Preferably, the aforementioned storage will be in a multi-layer form, for example based on the Fekete-Beaudouin-Lafon model extended to take account of external “physical” information. In this multi-layer model, illustrated in FIG. 2, a first layer 17, termed the “paper layer”, can correspond to data pre-printed on the page 12 of the laboratory notebook 3, such as for example the header 16, the page numbers 13 and the input masks; a second layer 18, termed “ink layer”, can correspond to the primary data 19 “inscribed” in the entry zones 4 of the page 12; and a third layer 20, termed “annotation layer”, can correspond to the secondary data 21 and 22 added to the primary data in the ink layer 18 after it has been saved for the first time, and to which further reference will be made below.

Preferably, the information (primary data) 19 belonging to the ink layer 18 cannot be altered, so that a certain indisputable date can be assigned thereto.

Preferably also, the page-files are stored in an XML type format, and each layer of a page-file is represented in an SVG type vector format (described in particular at the address “http://www.w3c.org/svg”). Of course, other types of storage format and representation format can be envisaged.

When a user wishes to read the information contained in his/her laboratory notebook, he/she either uses said notebook (as writing medium 1), or uses the application controlled by the processing module 10 of the computer 1, which retrieves the corresponding folder from the memory 15 or from the database 9 residing on the corporate network. The folder is then displayed on the screen 7 of the computer 1, and the user can select one of the page-files, via the interaction module 8. The latter then addresses instructions (or commands) to the display such that the selected page is displayed on the screen 7.

In addition, the application controlled by the processing module 10 presents the user, on the graphic tablet 5, with a menu of dedicated commands 14 controlled by the interaction module 8 and enabling him/her to perform various operations. The range of possible operations includes in particular:
addition of secondary elements, such as written characters (letters, numbers, drawing lines), references of any kind (scanned or written), addresses or links of any kind (possibly imported), in particular internal or external data sources, barcodes (scanned or imported as the case may be) designating any type of object or any type of document residing on the corporate network, images (scanned or imported as the case may be), and the like;
association of processing operators to primary data. These operators can include in particular an operator to bracket data and an operator to underscore data.

A secondary data item or a processing operator can be written or incorporated using one of the dedicated commands 14 managed by the interaction module 8.

The entry may be written directly onto the writing medium 3, or on an additional piece of paper, such as a Post-It®. In the latter case, the user places the Post-It® in the desired position on the writing medium 3, executes one of the dedicated commands 14 provided for this purpose, then enters the secondary characters on the Post-It®, and executes the dedicated command 14 once more when finished.

Integration can be performed on a text, an image or a diagram, scanned, directly, or imported from an internal (9) or external data source (Internet). In addition, the integration can be accompanied by a scaling operation so that the element in question is made to fit into a window defined manually by the user on the page 12 of the laboratory notebook 3, for example by means of lines defining two diametrically opposing angles.

The underscore operator serves, for example, to tell the processing module 10, via the interaction module 8, that the corresponding text is a link or an address (URL for example) to an internal or external data source (a site accessible via the Internet for example). Thus, when the user activates data defining a link, using one of the dedicated commands 14, the processing module 10 instructs the central processing unit 2 to establish the connection with the data source designated by said link and the information contained in this source (for example “web” pages) is imported into the central processing unit then displayed on the screen 7 (or the PDA). The user can then browse said information and/or establish links with other sources of information. Of course, to activate data defining a link the user can either apply pressure on the data inscribed on the writing medium 3 (laboratory notebook), or apply pressure on the data displayed on the screen 7 (or the PDA), or select this data with the mouse of the computer 1. The underscore operator can also be used by the user to indicate that certain characters are required to undergo a recognition process.

Preferably, all underscored data, defining links or addresses, are listed in an index in correspondence with their respective timestamps and zone identifiers. This index is preferably updated regularly.

The bracketing operator can, for example, serve to tell the processing module 10, via the interaction module 8, that the bracketed text is associated with a search identifier, such as <<PCR>> or <<RMN>> for example. In this way, when a user performs a search on one of the identifiers, all the user needs to do is write the chosen identifier on any page of the laboratory notebook or in a window of the screen 7 (or PDA), then select the dedicated command 14 defining the search function, in order to cause all of the bracketed portions in the documents stored in the database 9, and associated with this identifier, to be imported then displayed on the screen 7 of the computer 1.

Recognition of underscored and bracketed elements by the processing module 10 can be based for example on Rubin's algorithm.

As previously indicated, the secondary data which is inscribed on the writing medium 3, in this instance a page 12 of a laboratory notebook 3, or associated with the primary data that it contains, is converted into secondary digital data which is transmitted to the processing module 10, accompanied by position data.

When the user has finished annotating the selected page 12, he/she executes a dedicated command 14 in the menu proposed by the graphic tablet 5, or a dedicated command in a menu of the application managed by the processing module 10 and displayed on the screen 7 of the computer 1, to tell the processing module 10 that it can process the secondary data received.

At this stage, the processing involves associating a timestamp representing the time of data entry and an identifier representing their assigned zone, in this instance a page 12 of the laboratory notebook 3, with the secondary data and corresponding position data. The secondary data, position data, timestamp and page identifier are stored in the memory 15 of the central processing unit 2, in the annotation layer 20 of the page-file of the folder corresponding to the user's laboratory notebook 3. The processing module 10 can then be configured to transfer automatically, or at the user's command, the updated folder (or the updated page-file only) to the database 9 residing on the corporate network.

Preferably, the processing module 10 is arranged so as to automatically generate for each laboratory notebook (or more generally each document) a table of contents containing the associated identifiers links and addresses, so as to facilitate searching or browsing within said file. It is important to note that by virtue of the data timestamp and associated identifiers, the search can be based not only on one or more identifiers, but also on a selected date or period.

The search function can also be based on a selected portion of text for example by virtue of the fact that its font has been modified.

The commands 14 in the menu can also include a correction function enabling a user to select a portion of text that he/she wishes to correct or simply to check. In this case, the selected portion is displayed on the screen 7 (or the PDA), preferably after having been enlarged.

Several variants of the embodiment described above can be envisaged.

In a first variant, the interaction module 8 can be at least partially installed in an electronic input screen, of the type proposed by the company Gyricon or by the Massachusetts Institute of Technology. Such a screen simultaneously provides for the display, the entry zone for handwritten characters, and the recognition of said characters. This screen simply needs to be connected, by hard-wired or wireless means (for example via an infrared or Bluetooth interface), to a central processing unit 2 equipped with the processing module 10 according to the invention.

In a second variant, illustrated in FIG. 3, the interaction module 8 is installed entirely in the computer 1. More precisely, the computer 1, which can be of the portable type, includes an electronic input screen 7 linked to a recognition module 5 and to an interaction module 8 combined with an electronic pen 26. A computer of this kind supporting the recognition of written characters is proposed in particular by the company Microsoft under the name Windows XP Tablet PC Edition. Character recognition is accomplished for example by means of a grid operating on the electromagnetic resonance principle. This type of computer has the advantage of combining in a single data-processing unit the display, the entry zone for handwritten characters, the recognition of said characters, and the link to internal or external data sources.

In a third variant, the interaction module 8 is at least partially installed in a PDA 23. In this case, two embodiments can be envisaged.

A first embodiment of this third variant entails using the PDA 23 as a complement to the computer 1 described above, in particular for the purpose of making changes and/or additions to the primary data. In this case, advantage is taken of the fact that the PDA 23 is already equipped from the outset with handwriting recognition means and interaction means enabling the user to work with the aid of a dedicated pen 26 on the document displayed on its screen. The recognition module 5, equipped with the writing medium 3, converts the primary characters entered via said medium 3 into primary digital data then transmits this data to the part of the processing module 10 installed in the central processing unit 2 of the computer 1 to which it is linked. The latter can then transmit all or part of the primary data received, or primary and/or secondary data extracted from a data source, to the part of the processing module 10 installed in the PDA, such that said data is displayed on the associated screen 24 where it is possibly subjected to modification or addition of secondary data by means of dedicated commands offered by the pop-up menu of the associated interaction module 8 and a dedicated pen 26, at any location, according to the method described above in reference to FIG. 1. If the modification or addition is carried out at a distance beyond the range of the communications interface of the PDA 23, the corresponding page-file is stored temporarily in said PDA, then transferred as soon as said PDA is once again connected to the computer 1, for processing therein.

Of course, the interaction module 8 of the PDA 23 must be adapted or reconfigured in order to make the functions described above available to the user.

Such a PDA can be linked to a computer with integral graphic tablet, of the type described above in reference to FIG. 3.

A second embodiment of the third variant, illustrated in FIGS. 4 and 5, entails using the display 24 of the PDA 23 as the main display. In this case, the PDA 23 is equipped with a part of the processing module 10 (the other part being installed in the computer 1), handwriting recognition means and interaction means 8 which, being already present from the outset, only need to be adapted or reconfigured. It is also linked to the recognition module 5, in this instance the graphic tablet, and to the other part of the processing module 10, installed in the central processing unit 2 of the computer, in particular for the purpose of establishing connections with internal or external data sources. The primary characters written by the user on the writing medium 3 are converted into primary digital data by the recognition module 5, which then transmits this data to the part of the processing module 10 installed in the PDA 23. This primary data can then be displayed on the screen 24 of the PDA portion by portion if the user so wishes.

The processing module 10 can for example be written in Java, with the exception of the part providing the interface with the recognition module 5, which is preferably written in C. But, of course, any other type of computer language can be used.

The drawback of this embodiment is that it obliges the user to scroll the text containing the received primary data in order to select the part of the text to be worked on. To remedy this drawback, the invention makes provision to equip the PDA 23 with a tracking device 25 intended to determine its position in relation to the writing medium 3, by exchanging information with the recognition module 5. To do this, it is possible in particular to use a graphic tablet such as the Intuos, and a tracking device 25 such as the 4D mouse, marketed by the company WACOM. This combination of electronic elements makes it possible to determine not only the relative position of the PDA 23 in relation to the writing medium 3, placed on the graphic tablet 5, but also any rotation that it undergoes relative to said medium 3. Consequently, the recognition module 5 addresses to the PDA 23 only the primary data matching the primary characters inscribed on the portion of the writing medium 3 positioned substantially under it.

As illustrated in FIG. 4, in case of a difference in orientation between the PDA 23 and the writing medium 3, the information inscribed on the writing medium 3 is not straightened before being displayed on the screen 24, so that the PDA acts as a kind of interactive lens (or magnifying glass).

The tracking device 25 must be pre-calibrated. Also, the management module controlling the tracking device 25 is preferably installed in the PDA 23. It communicates with the recognition module 5 and the two parts of the processing module 10 for example via a Java Remote Method Invocation application (more generally known by the acronym JRMI). The Java objects are shared by virtue of being stored in an object container in an RMI registry.

Of course, any other mode of communication can be envisaged.

Each module can access the shared objects stored in the container by calling them by name, regardless of their respective physical locations. The shared objects include the database 9 holding the documents (laboratory notebooks) in XML format. When the PDA 23 is not sufficiently powerful to transcribe in real time the multi-layer description of the pages in SVG format, this operation is performed by the part of the processing module 10 installed in the computer 1, for example using the Batik protocol described at the address “http://xml.apache.org/batik/”. Thus, the part of the processing module 10 installed in the PDA 23 is only then required to handle the images in bitmap format. The latter receives updated images from the computer 1 in the form of compressed tiles of raster data. Each image is transformed by the computer 1 by means of an affine transformation taking into account the current position and orientation of the PDA 23, which is notified in the event of a change.

Of course, in this embodiment, the primary and/or secondary data displayed on the screen 24 of the PDA 23 can also originate from an external data source (the Internet for example) or an internal data source (the database 9 for example), via the part of the processing module 10 installed in the central processing unit 2 of the computer 1. Therefore, it is also possible to load into the memory of the PDA 23 one or more documents containing primary and/or secondary data, so that they can, if necessary, undergo modification or addition of secondary data and/or processing operators via the dedicated commands offered by the pop-up menu of the interaction module 8 and a dedicated pen 26, at any location, in accordance with the method described above in reference to FIG. 1. If the modification or addition is performed at a distance beyond the range of the communications interface of the PDA 23, the corresponding page-file is stored temporarily in said PDA, then transferred as soon as said PDA is once again connected to the computer 1, to be processed therein.

Furthermore, in this second embodiment, it is not essential to connect a monitor 6 to the central processing unit 2 of computer 1, or it can serve as an auxiliary screen intended to facilitate reading of the information inscribed on the writing medium 3 and converted into primary data by the recognition module 5, and for the display of information imported from internal or external data sources linked to the primary data. Where such a monitor 6 is provided, it is also possible to equip the computer 1 with an interaction module 8.

It is also possible to provide, among the dedicated commands of the application, a correction function enabling a user to select, with the aid of a dedicated pen 26, a portion of text 27 that he/she wishes to correct or simply to check. In this case, the selected portion 27 is displayed on the screen 24 of the PDA 23, possibly after having been enlarged.

Such a PDA can be connected to a computer with integral graphic tablet, of the type described above in reference to FIG. 3.

The invention has been presented above in the form of an installation. However, it can also be presented in the form of a data processing device intended to be installed in a centralized or distributed manner in one or more data-processing units of the installation, such as for example a computer and/or external recognition module, such as a graphic tablet, and/or a PDA.

This data processing device includes processing means 10 arranged so as to:
address instructions to a display device 6, said instructions requiring the display of at least one part of handwritten primary data captured by recognition means 5 after being entered by a user in a zone 4 of a writing medium 3;
associate a timestamp representing the time of data entry or association and an identifier representing the zone 4 with the primary data, and with processing operators and/or secondary data, associated by interaction means 8 with at least some of the primary data displayed by the display 6 device, and
access the database, in case of activation by the interaction means 8 (at the user's command) of primary or secondary data designating external data stored in at least one database 9, such that this external data is displayed by the display device 6.

The processing and interaction modules presented above can be implemented in the form of electronic circuits, software (or data processing) modules, or a combination of circuits and software. Furthermore, the recognition means of the invention can be of any type, provided that they are capable of capturing primary data in any form, and in particular handwritten characters.

By virtue of the invention, it is possible in particular to capture data written by a user on a writing medium, such as a laboratory notebook or input screen, to select some of this data in order to assign an identifier thereto enabling it to be readily retrieved and/or to associate it with other data, such as for example URL addresses, identifiers designating internal or external databases, objects or locations residing on a server, or images.

In addition, it is also possible to display the pages of a document, such as a laboratory notebook, stored in a database, or a selected part of a document in response to a user command.

It is also possible to manage links between data captured in a document and data of the same type within the same document or another document of the same type, or a data source associated with said captured data by means of a chosen identifier.

The invention is therefore suitable for numerous applications, such as for example in the field of research (laboratory notebooks used in particular by biologists, pharmacists, chemists, and more generally all researchers), or for the management of schedules or planning charts, or for note-taking during meetings or courses, and has general relevance to all applications in which handwritten marks can be used to access on-line data, or where the timestamp of the handwritten marks can be used in particular for archiving purposes.

1. Data-processing installation, characterized in that it includes:
a writing medium (3) defining at least one zone (4) adapted for the entry of handwritten primary data by a user;
recognition means (5) arranged to capture said primary data entered in said field (4),
a display device (6) arranged to display data;
interaction means (8) arranged to enable a user i) to associate processing operators and/or secondary data with primary data entered in said field (4), and ii) to activate primary data entered or associated secondary data when it designates external data stored in at least one database (9);
processing means (10) arranged i) to associate a timestamp representing the moment of data entry or association and an identifier representing the zone (4) with said Processing operators and/or said primary or secondary data, and ii) in case of activation of primary or secondary data by a user, to access the database (9) in which the external data designated by said actiated primary or secondary data is stored, such that this external data is displayed by said display device (6);

2. Installation according to claim 1, characterized in that it includes a memory (15) linked to said processing means (10), and in that said processing means (10) are arranged to store in said memory (5) the primary and secondary data in correspondence with their timestamps and/or their respective zone identifiers.

3. Installation according to claim 1, characterized in that said processing means (10) are arranged to associate primary level identifiers (18) and secondary level identifiers (20) with said primary and secondary data in a zone (4), such that said zone (4) and its data can be broken down into levels.

4. Installation according to claim 3, characterized in that said medium (3) is arranged to deliver tertiary data representing an input mask of said zone (4) to said processing means (10), and in that said processing means (10) are arranged to associate tertiary level identifiers (17) with said tertiary data in a zone (4) before storing the data in said memory (15).

5. Installation according to claim 1, characterized in that said recognition means (5) include a pen arranged to enable a user to enter primary and/or secondary data via said medium (3), and to capture the primary and/or secondary data thus entered and to communicate it to said processing means (10).

6. Installation according to claim 1, characterized in that said recognition means (5) include a pen arranged to enable a user to enter primary and/or secondary data via said medium (3), to capture this primary and/or secondary data thus entered in cooperation with said recognition means (5), and to communicate it to said processing means (10).

7. Installation according claim 1, characterized in that said recognition means (5) include a graphic tablet capable of accommodating said medium (3) and arranged to capture said primary and secondary data entered via said medium (3) and to communicate it to said processing means (10).

8. Installation according to claim 1, characterized in that said medium (3) is an electronic notebook defining a multiplicity of zones (4) for the entry of primary and/or secondary data.

9. Installation according claim 1, characterized in that it includes at least one computer (1) incorporating said display device (5), said recognition means (5) and at least one part of said processing means (10).

10. Installation according to claim 1, characterized in that in includes at least one computer (1) incorporating said display device (6), said recognition means (5) and at least one part of said processing means (10).

11. Installation according to claim 10, characterized in that said display device (6) also constitutes said medium (3).

12. Installation according to claim 1, characterized in that said computer (1) includes at least one part of said interaction means (8).

13. Installation according to claim 1, characterized in that it includes a personal digital assistant (23) including an auxiliary display (24) arranged to enable the entry of secondary data by a user, at least one part of said interaction means (8), at least one part of said processing means (10), and a part of said recognition means (5) so as to capture said secondary data entered via said auxiliary display (24).

14. Installation according to claim 13, characterized in that it includes tracking means (25) integral with said personal digital assistant (23), connected to said recognition means (5), and arranged to determine the position of the auxiliary display (24) relative to said medium (3), such that the part of said zone displayed on said auxiliary display (24) substantially matches the portion of the zone (4) of the medium (3) located under said auxiliary display (24).

15. Installation according to claim 9, characterized in that said computer (1) is connected to the Internet and/or to at least one private database (9).

16. Data processing device, characterized in that it includes processing means arranged to:
address to a display device (6; 24) instructions requiring the display of at least one part of handwritten primary data captured by recognition means (5) after being entered by a user in a zone (4) of a medium (3);
associate a timestamp representing the moment of data entry or association and an identifier representing the zone (4) with said primary data, and with processing operators and/or secondary data, associated by interaction means (8) with at least some of said primary data displayed by said display device (6; 24), and
in case of activation by said interaction means (8) of primary or secondary data designating external data stored in at lest one database (9), to access said database, such that this external data is displayed by said display device (6; 24).

17. A method of using a data processing installation comprising the steps of inputting data from a writing medium (3) and displaying data in a display device (6) wherein the data processing installation comprises:
a processing means as recited in claim 16;
said writing medium (3) defining at least one zone (4) adapted for the entry of handwritten primary data by a user;
recognition means (5) arranged to capture said primary data entered in said field (4),
said display device (6) arranged to display data; and
interaction means (8) arranged to enable a user i) to associate processing operators and/or secondary data with primary data entered in said field (4), and ii) to activate primary data entered or associated secondary data when it designates external data stored in at least one database (9).
